(19) United States
(12) Patent Application Publication
(10) Pub. No.: US 2006/0289506 A1
(43) Pub. Date: Dec. 28, 2006

(54) Apparatus and method for controlling cooling time of microwave oven

(75) Inventors: Jong Chull Shon, Suwon-Si (KR); Won Woo Lee, Suwon-Si (KR); Geun Soo Kim, Suwon-Si (KR); So Hyun Lee, Suwon-Si (KR); Kum Chul Hwang, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., LTD., Suwon-si (KR)

(21) Appl. No.: 11/304,569

(22) Filed: Dec. 16, 2005

(30) Foreign Application Priority Data
May 25, 2005 (KR) 2005-44133

(51) Int. Cl. H05B 6/50

(52) U.S. Cl. 219/707

(57) ABSTRACT

An apparatus and method for controlling cooling time of a microwave oven that is capable of controlling an initial cooling time, which is given to secure stable operational characteristics of a sensor, when sensor-based automatic cooking is performed, thereby reducing total cooking time. The cooling time control method includes determining whether sensor-based automatic cooking is performed, when the sensor-based automatic cooking is performed, operating a cooling fan to perform cooling operation such that a sensor is cooled, sensing an output value of the sensor, when the cooling operation is performed, to calculate a change of the sensor output value, and comparing the calculated change of the sensor output value with a predetermined reference value, and, when the change of the sensor output value exceeds the predetermined reference value, controlling cooling time based on the change of the sensor output value.

### CROSS-REFERENCE TO RELATED APPLICATIONS

This application claims the benefit of Korean Patent Application No. 2005-44133, filed on May 25, 2005 in the Korean Intellectual Property Office, the disclosure of which is incorporated herein by reference.

### BACKGROUND OF THE INVENTION

1. Field of the Invention

The present invention relates to a microwave oven. More particularly, to an apparatus and method for controlling cooling time of a microwave oven that is capable of controlling initial cooling time which is given to secure stable operational characteristics of a sensor when sensor-based automatic cooking is performed, thereby reducing total cooking time.

2. Description of the Related Art

Generally, a conventional microwave oven is an apparatus that induces vibration of water molecules contained in food to be cooked with microwaves of approximately 2450 MHz, which are generated when high-voltage electricity is applied to a high frequency oscillating tube, i.e., a magnetron, and quickly heat the food using frictional heat generated by the vibration of the water molecules.

A sensor is mounted in the conventional microwave oven, such as a humidity sensor or a gas sensor, which is used when automatic cooking of potatoes or corn is performed. However, the sensor does not have stable operational characteristics when the microwave oven is in continuous use or when the sensor is used at an initially high temperature.

When the conventional microwave oven is in continuous use or when the sensor is used at the initially high temperature, the temperature of the sensor is already high, and therefore, it is difficult for the sensor to perform normal sensing operation. Furthermore, when the sensor reads the humidity in a cooking chamber of the microwave oven to set an initial condition considering a previously performed cooking condition, a sensor output value is unstable.

In order to solve the above-mentioned problems, a cooling fan is operated for predetermined cooling time (for example, approximately 10 to 30 seconds), as shown in FIGS. 1A and 1B, before automatic cooking (for example, cooking of potatoes or corn) is performed using the sensor, according to the conventional art, such that humidity or gas is discharged out of the cooking chamber to ventilate the cooking chamber, and the sensor is cooled by air stream generated when the cooking chamber is ventilated. As a result, the sensor has stable operational characteristics.

In the conventional method of operating the cooling fan for the predetermined cooling time to cool the sensor as shown in FIGS. 1A and 1B, however, the temperature of the sensor, the humidity in the cooking chamber, or the interior temperature of the cooking chamber is not considered. As a result, the initial cooling time is added to real cooking time. Consequently, total cooking time of the microwave oven is increased, and therefore, power consumption is increased.

### SUMMARY OF THE INVENTION

Therefore, it is an aspect of the invention to provide an apparatus and method for controlling cooling time of a microwave oven that is capable of variably controlling initial cooling time based on a change of a sensor output value when sensor-based automatic cooking is performed, thereby reducing total cooking time.

Additional aspects and/or advantages of the invention will be set forth in part in the description which follows and, in part, will be apparent from the description, or may be learned by practice of the invention.

The foregoing and/or other aspects of the present invention are achieved by providing a method for controlling cooling time of a microwave oven, the method including determining whether sensor-based automatic cooking is performed, operating a cooling fan to perform a cooling operation such that a sensor is cooled when the sensor-based automatic cooking is performed, sensing an output value of the sensor, when the cooling operation is performed, to calculate change of the sensor output value, and comparing the calculated change of the sensor output value with a predetermined reference value, and when the calculated change of the sensor output value exceeds the predetermined reference value, controlling the cooling time based on the calculated change of the sensor output value.

The sensor output value is sensed at an interval of a predetermined period of time to successively calculate the change of the sensor output value.

The cooling time is variably controlled based on the successively calculated change of the sensor output value, and the cooling time is directly proportional to the change of the sensor output value.

A magnetron is operated to initiate cooking operation when the calculated change of the sensor output value does not exceed the reference value.

It is another aspect of the present invention to provide a method for controlling cooling time of a microwave oven, the method including determining whether sensor-based automatic cooking is performed, sensing an output value of a sensor when the sensor-based automatic cooking is performed, comparing the sensed sensor output value with a predetermined reference value, and when the sensor output value exceeds the predetermined reference value, setting cooling time based on the sensor output value, and operating a cooling fan based on the set cooling time to perform a cooling operation such that the sensor is cooled.

A magnetron is operated to initiate a cooking operation when the sensor output value does not exceed the predetermined reference value.

The sensor is at least one of a humidity sensor, a gas sensor and a temperature sensor, and the sensor is disposed such that the sensor comes into contact with air circulating in the cooking chamber.

It is yet another aspect of the present invention to provide an apparatus for controlling cooling time of a microwave oven, the apparatus including an input unit to select sensor-based automatic cooking mode, and a control unit to operate a cooling fan such that a cooling operation is performed to cool a sensor when cooking is performed in the sensor-based automatic cooking mode, to sense an output value of the sensor when the cooling operation is performed, and to control the cooling time based on the sensor output value.

The control unit senses the sensor output value at an interval of a predetermined period of time to successively calculate change of the sensor output value. Also, the control unit compares the change of the sensor output value with a predetermined reference value, and, when the change of the sensor output value exceeds the predetermined reference value, the control unit variably controls the cooling time based on the change of the sensor output value.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A is a graph illustrating cooking time when potatoes are cooked by a conventional microwave oven;

FIG. 1B is a graph illustrating cooking time when corn is cooked by the conventional microwave oven;

FIG. 2 is an exploded perspective view illustrating a microwave oven according to an embodiment of the present invention;

FIG. 3 is a sectional view illustrating an air circulation structure of the microwave oven according to an embodiment of the present invention;

FIG. 4 is a block diagram illustrating an apparatus for controlling cooling time of the microwave oven according to an embodiment of the present invention;

FIG. 5 is a flow chart illustrating a method for controlling cooling time of the microwave oven according to an embodiment of the present invention;

FIG. 6 is a graph illustrating change in gradient of a sensor output value according to an embodiment of the present invention;

FIG. 7 is a graph illustrating comparison between cooling times based on change in gradient of a sensor output value according to an embodiment of the present invention; and

FIGS. 8A to 8D are graphs illustrating cooling time changed based on change in gradient of a sensor output value according to an embodiment of the present invention.

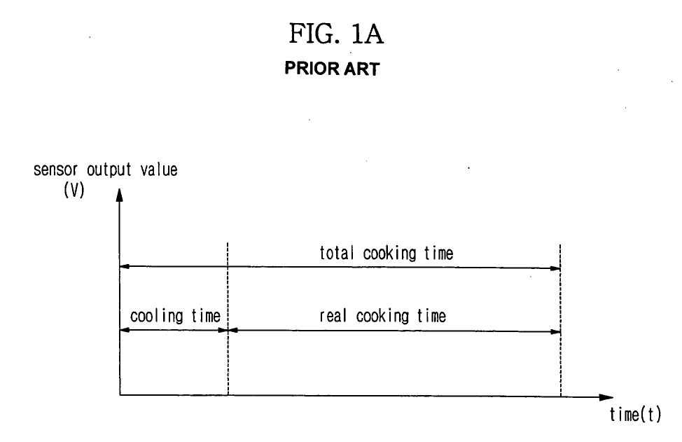

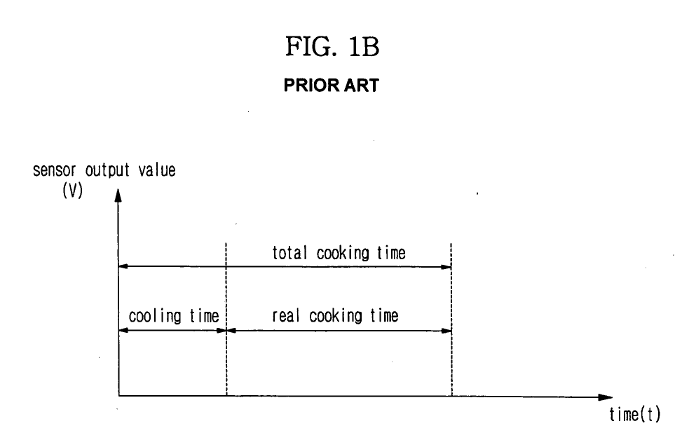

### DETAILED DESCRIPTION OF THE PREFERRED EMBODIMENTS

Reference will now be made in detail to the embodiment of the present invention, examples of which are illustrated in the accompanying drawings, wherein like reference numerals refer to like elements throughout. The embodiment is described below to explain the present invention by referring to the figures.

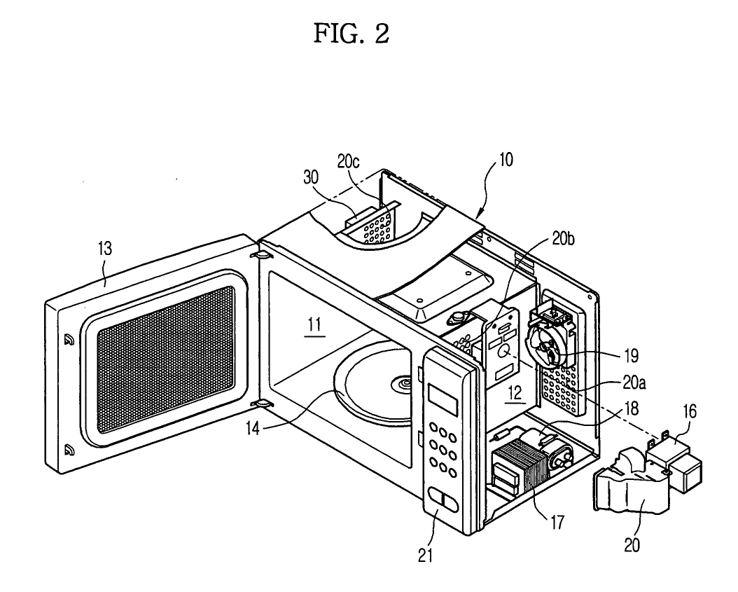

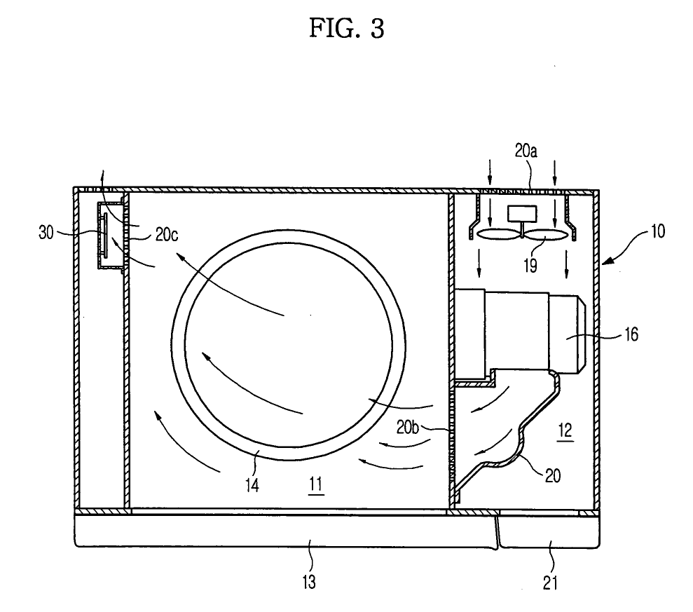

FIG. 2 is an exploded perspective view illustrating a microwave oven according to the present invention, and FIG. 3 is a sectional view illustrating an air circulation structure of the microwave oven according to the present invention.

As shown in FIGS. 2 and 3, the microwave oven comprises an oven body 10, which is partitioned into a cooking chamber 11, in which food is cooked, and a machinery chamber 12, in which various electric parts are mounted. The cooking chamber 11 has an open front surface, through which food is put into the cooking chamber 11. At the open front surface of the cooking chamber 11 is mounted a door 13 for opening and closing the cooking chamber 11. In the cooking chamber 11 is rotatably disposed a turntable 14, on which the food is placed.

In the machinery chamber 12 are mounted a magnetron 16 to supply high frequency electromagnetic radiation into the cooking chamber 11, a high-voltage transformer 17 and a high-voltage condenser 18 to apply high voltage to the magnetron 16, a cooling fan 19 to cool the magnetron 16, the high-voltage transformer 17 and the high-voltage condenser 18, and an air guide duct 20 to guide air out of the machinery chamber 12.

When the cooling fan 19 is operated, as shown in FIG. 3, outside air (i.e., air outside the microwave oven) is introduced into the machinery chamber 12 through an inlet port 20a to cool the electric parts mounted in the machinery chamber 12. Subsequently, the air is guided along the air guide duct 20, and is then supplied into the cooking chamber 11 through an opening 20b. After that, the air is discharged out of the cooking chamber 11, together with steam generated from the food, through an outlet port 20c.

At one side of the outlet port 20c is mounted a humidity sensor 30 to sense the humidity of air in the cooking chamber 11. That is, a cooking condition of the microwave oven is sensed by the humidity sensor 30. The humidity sensor 30 is disposed such that the humidity sensor 30 comes into contact with the air discharged from the cooking chamber 11 through the outlet port 20c. The humidity sensor 30 serves to sense moisture contained in the steam generated from the food when the cooking operation of the microwave oven is performed.

In the illustrated embodiment, the humidity sensor 30 is provided to sense the cooking condition of the microwave oven when the automatic cooking is performed, although the cooking condition of the microwave oven may be sensed by a gas sensor or a temperature sensor.

At the front surface of the machinery chamber 12 is mounted a manipulation panel 21 to allow a user to select desired cooking function and display the selected cooking function and the operation state.

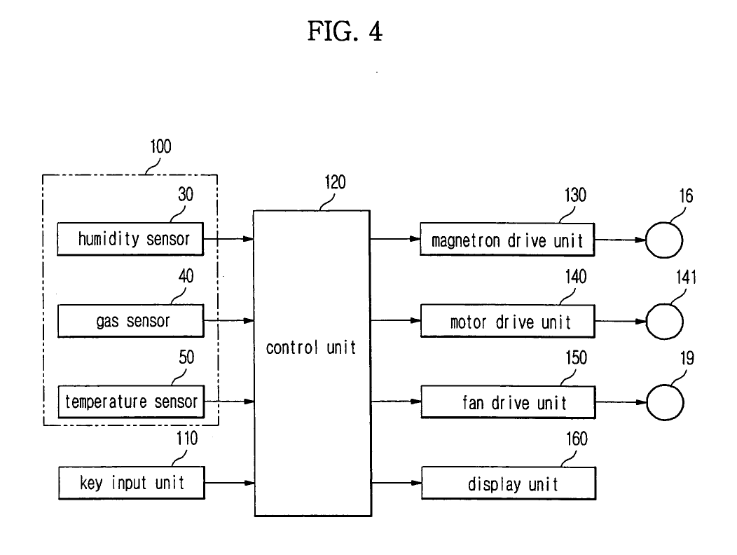

FIG. 4 is a block diagram illustrating an apparatus for controlling cooling time of the microwave oven according to the present invention. The cooling time control apparatus comprises a sensor unit 100, a key input unit 110, a control unit 120, a magnetron drive unit 130, a motor drive unit 140, a fan drive unit 150, and a display unit 160.

The sensor unit 100 senses the cooking condition of the cooking chamber 11, which is changed when automatic cooking is performed, i.e., the state of food. The sensor unit 100 comprises at least one of a humidity sensor 30 to sense the humidity of air in the cooking chamber 11, a gas sensor 40 to sense the amount of gas in the cooking chamber 11, and a temperature sensor 50 to sense the interior temperature of the cooking chamber 11. The sensors 30, 40 and 50 are disposed at one side of the outlet port 20c such that the sensors 30 come into contact with the air discharged from the cooking chamber 11.

The key input unit 110 allows a user to input desired cooking information, such as, cooking time, cooking item, sensor-based automatic cooking, cooking start/stop, etc., to the control unit 120. The key input unit 110 comprises a plurality of keys, which are disposed on the manipulation panel 21.

The control unit 120 is a microprocessor that controls the respective components of the microwave oven, and controls output of microwaves according to the determination of the state of food based on a sensor output value input from the sensor unit 100 when automatic cooking is performed. The control unit 120 calculates a change of the sensor output value input from the sensor unit 100 based on time (i.e., a change in gradient), compares the change in gradient with a predetermined reference value, and variably controls an initial cooling time, which is given to secure stable operational characteristics of the sensors 30, 40 and 50, based on the result of the comparison. Thus, the control unit 120 controls the total cooking time.

The magnetron drive unit 130 comprises a relay to control the operation of the magnetron 16 such that the magnetron 16 generates microwaves based on the control signal of the control unit 120. The motor drive unit 140 drives a motor 141, by which the turntable is rotated, based on the control signal of the control unit 120.

The fan drive unit 150 drives the cooling fan 19, by which the machinery chamber 12 is cooled, based on the control signal of the control unit 120 such that the cooking chamber 11 is ventilated. The sensors 30, 40, and 50 are cooled by air stream generated when the cooking chamber is ventilated such that the sensors 30, 40, and 50 have stable operational characteristics.

The display unit 160 displays the cooking time, the cooking item or the operation state of the microwave oven input by the user based on the control signal of the control unit 120 on the manipulation panel 22.

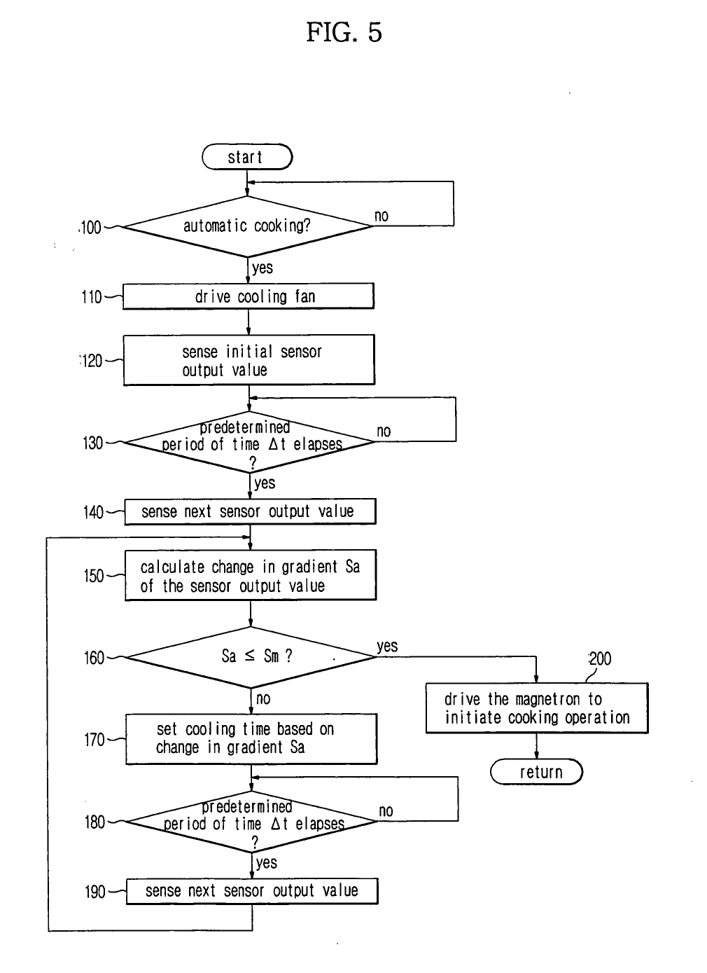

A method for controlling cooling time of the microwave oven according to an embodiment of the present invention will be described in detail with reference to FIG. 5.

FIG. 5 is a flow chart illustrating the method for controlling cooling time of the microwave oven according to an embodiment of the present invention. In the following description, the cooling time control method is applied to the microwave oven that performs automatic cooking using the humidity sensor 30.

In operation 100, when a user places food to be cooked on the turntable 14 in the cooking chamber 11, and manipulates the manipulation panel 21 to select desired cooking information (for example, sensor-based automatic cooking), a key signal selected by the user is input to the control unit 120 through the key input unit 110.

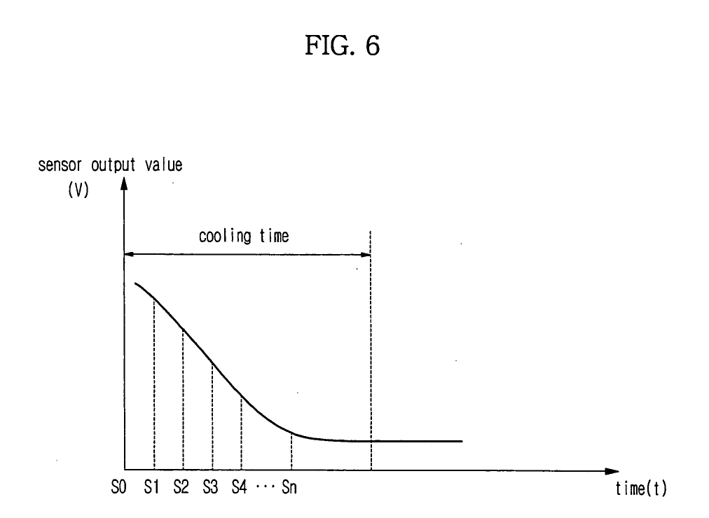

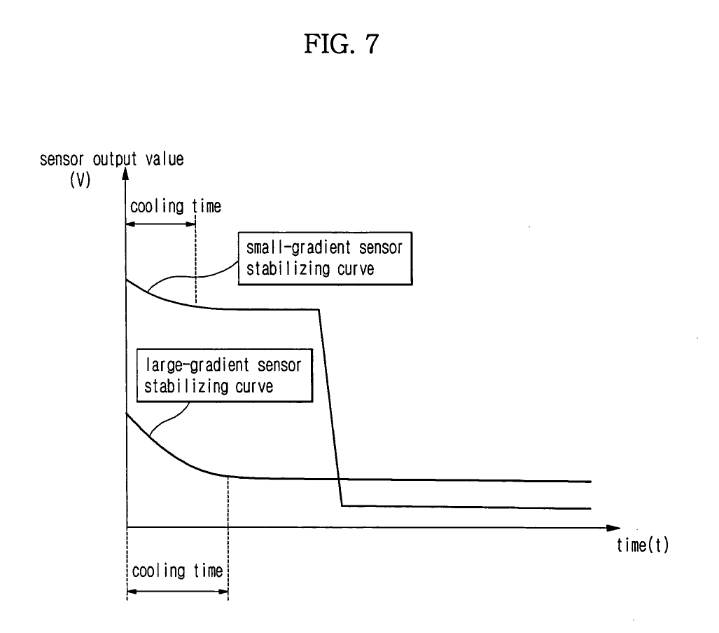

From operation 100, the process moves to operation 110 where the control unit 120 operates the cooling fan 19, such that the humidity sensor 30 has stable operational characteristics as shown in FIGS. 6 and 7, before the cooking process is initiated.

When the cooling fan 19 is operated, as shown in FIG. 3, outside air (i.e., air outside the microwave oven) is introduced into the machinery chamber 12 through the inlet port 20a to cool the electric parts mounted in the machinery chamber 12. Subsequently, the air is guided along the air guide duct 20, and is then supplied into the cooking chamber 11 through the opening 20b. After that, the air is discharged out of the cooking chamber 11, together with moisture or gas left in the cooking chamber 11, through the outlet port 20c. In this way, the cooking chamber 11 is ventilated.

The humidity sensor 30, which is mounted at one side of the outlet port 20c, is cooled by air stream generated when the cooking chamber 11 is ventilated such that the humidity sensor 30 has stable operational characteristics. In this way, the initial cooling operation is performed.

From operation 110, the process moves to operation 120 where when the cooling operation is performed by the cooling fan 19, an initial sensor output value S0 is sensed by the humidity sensor 30, which is input to the control unit 120, as shown in FIG. 6.

Subsequently, from operation 120, the process moves to operation 130 where the control unit 120 determines whether a predetermined period of time Δt elapses after the initial sensor output value S0 is sensed. When it is determined that the predetermined period of time Δt elapses in operation 130, the process moves to operation 140, where the next sensor output value S1 is sensed by the humidity sensor 30, which is input to the control unit 120, as shown in FIG. 6.

From operation 140 the process moves to operation 150, where the control unit 120 calculates change of the sensor output values S0 and S1 input from the humidity sensor 30 based on time, i.e., change in gradient Sa, and from operation 150, the process moves to operation 160 where it is determined whether the calculated change in gradient Sa is not more than a predetermined reference value Sm (change of the sensor output value when little humidity is present in the cooking chamber and the temperature of the sensor is normal).

When it is determined that the calculated change in gradient Sa is more than the reference value Sm in operation 160, the process moves to operation 170 where the control unit 120 determines that humidity is present in the cooking chamber or the temperature of the sensor is abnormal, and sets cooling time based on the change in gradient Sa.

As shown in FIG. 7, the cooling time necessary to cool the humidity sensor 30 is decreased in a small-gradient sensor stabilizing curve, and the cooling time necessary to cool the humidity sensor 30 is increased in a large-gradient sensor stabilizing curve.

From operation 170, the process moves to operation 180 where the control unit 120 determines whether the predetermined period of time Δt elapses after the sensor output value S1 is sensed. When it is determined that the predetermined period of time Δt elapses in operation 180, the process moves to operation 190 where the next sensor output value S2 is sensed by the humidity sensor 30, which is input to the control unit 120, as shown in FIG. 6.

In this way, the control unit 120 successively calculates change in gradient Sa of sensor output values S1, S2; S2, S3; . . . ; Sn-1, Sn input from the humidity sensor 30 at an interval of the predetermined period of time Δt in operation 150, and variably, controls the cooling time until the calculated change in gradient Sa is not more than the reference value Sm.

As an alternative, when it is determined that the calculated change in gradient Sa is not more than the reference value Sm in operation 160, the process moves to operation 200 where the control unit 120 determines that the humidity sensor 30 has stable operational characteristics, and controls the magnetron 16 to be driven to initiate the real cooking operation.

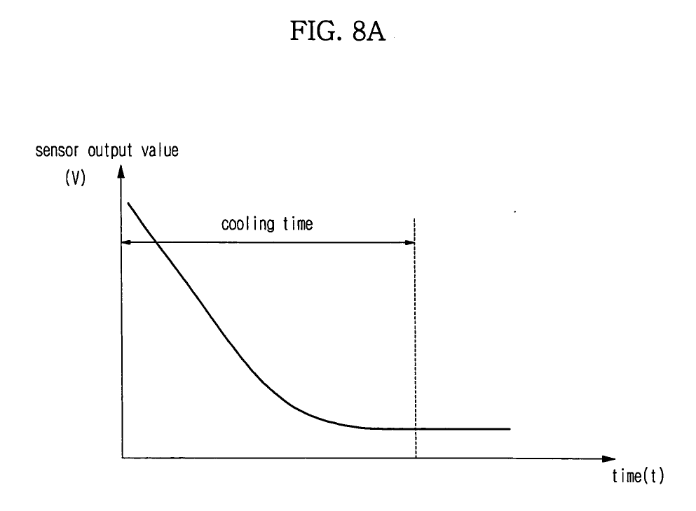

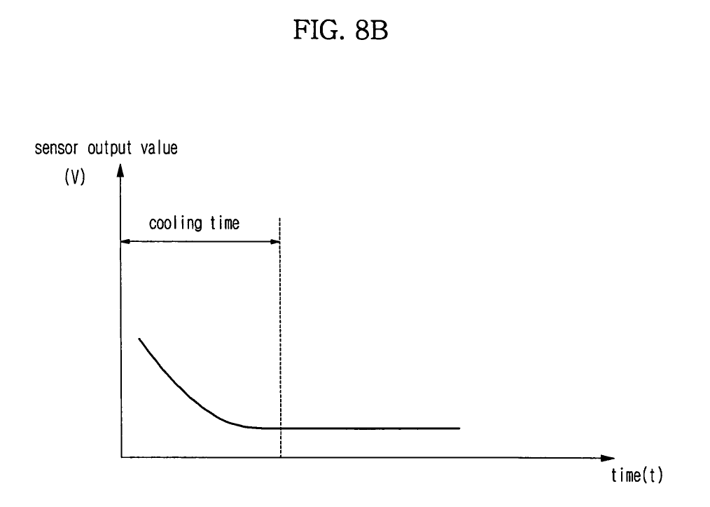

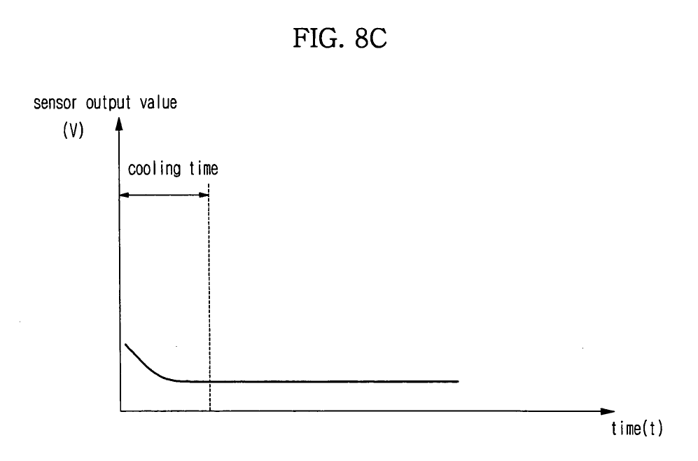

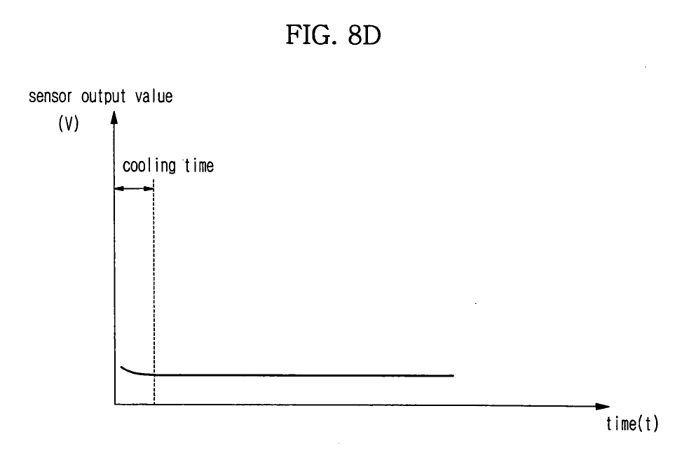

FIGS. 8A to 8D are graphs illustrating cooling time changed based on change in gradient of a sensor output value according to the present invention. Specifically, FIG. 8A is a graph illustrating cooling time when a large amount of humidity is present in the cooking chamber 11 or the temperature of the sensor is high, FIG. 8B is a graph illustrating cooling time when a small amount of humidity is present in the cooking chamber 11 or the temperature of the sensor is slightly high, and FIG. 8C is a graph illustrating cooling time when little humidity is present in the cooking chamber 11 and the temperature of the sensor is slightly high, and FIG. 8D is a graph illustrating cooling time when little humidity is present in the cooking chamber 11 and the temperature of the sensor is normal.

In FIGS. 8A to 8D, the cooling time is variably controlled based on the conditions in the cooking chamber 11 such that the humidity sensor 30 includes stable operational characteristics when the sensor-based automatic cooking is performed, and therefore, the total cooking time is reduced.

In the illustrated embodiment, the microwave oven performs automatic cooking using the humidity sensor 30, although the microwave oven may perform the automatic cooking using the gas sensor 40 or the temperature sensor 50, which will provide the same effects.

As apparent from the above description, the present invention provides an apparatus and method for controlling cooling time of a microwave oven that is capable of variably controlling cooling time based on change of a sensor output value when sensor-based automatic cooking is performed. Consequently, the present invention has the effects of reducing total cooking time, and therefore, saving energy.

Although an embodiment of the present invention has been shown and described, it would be appreciated by those skilled in the art that changes may be made in this embodiment without departing from the principles and spirit of the invention, the scope of which is defined in the claims and their equivalents.

What is claimed is:

1. A method for controlling cooling time of a microwave oven, comprising:
determining whether sensor-based automatic cooking is performed;
when the sensor-based automatic cooking is performed, operating a cooling fan to perform cooling operation such that a sensor is cooled;
sensing an output value of the sensor, when the cooling operation is performed, to calculate change of the sensor output value; and
comparing the calculated a change of the sensor output value with a predetermined reference value, and, when the change of the sensor output value exceeds the predetermined reference value, controlling cooling time based on the change of the sensor output value.

2. The method according to claim 1, wherein the sensor output value is sensed at an interval of a predetermined period of time to successively calculate the change of the sensor output value.

3. The method according to claim 2, wherein the cooling time is variably controlled based on the successively calculated change of the sensor output value.

4. The method according to claim 3, wherein the cooling time is directly proportional to the change of the sensor output value.

5. The method according to claim 1, wherein a magnetron is operated to initiate cooking operation when the change of the sensor output value does not exceed the predetermined reference value.

6. The method according to claim 1, wherein the sensor is at least one of a humidity sensor, a gas sensor and a temperature sensor.

7. The method according to claim 6, wherein the sensor is disposed such that the sensor comes into contact with air circulating in the cooking chamber.

8. A method for controlling cooling time of a microwave oven, comprising:
determining whether sensor-based automatic cooking is performed;
sensing an output value of a sensor when the sensor-based automatic cooking is performed;
comparing the sensed sensor output value with a predetermined reference value, and, when the sensor output value exceeds the predetermined reference value, setting the cooling time based on the sensor output value; and
operating a cooling fan based on the set cooling time to perform a cooling operation such that the sensor is cooled.

9. The method according to claim 8, wherein a magnetron is operated to initiate a cooking operation when the sensor output value does not exceed the predetermined reference value.

10. The method according to claim 8, wherein the sensor is at least one of a humidity sensor, a gas sensor and a temperature sensor.

11. The method according to claim 10, wherein the sensor is disposed such that the sensor comes into contact with air circulating in the cooking chamber.

12. An apparatus for controlling cooling time of a microwave oven, comprising:
an input unit to select sensor-based automatic cooking mode; and
a control unit to operate a cooling fan such that cooling operation is performed to cool a sensor when cooking is performed in the sensor-based automatic cooking mode, to sense an output value of the sensor when the cooling operation is performed, and to control the cooling time based on the sensor output value.

13. The apparatus according to claim 12, wherein the control unit senses the sensor output value at an interval of a predetermined period of time to successively calculate a change of the sensor output value.

14. The apparatus according to claim 13, wherein the control unit compares the change of the sensor output value with a predetermined reference value, and, when the change of the sensor output value exceeds the predetermined reference value, the control unit variably controls the cooling time based on the change of the sensor output value.
